(19) United States
(12) Patent Application Publication
(10) Pub. No.: US 2026/0037654 A1
(43) Pub. Date: Feb. 5, 2026

(54) SYSTEM AND METHOD FOR IMPLEMENTING DATA CATALOG BRIDGE TO DIRECTLY SOURCE ATTRIBUTES FOR IMPLEMENTING DYNAMIC DATA GOVERNANCE FOR ACCESS CONTROL

(71) Applicant: JPMorgan Chase Bank, N.A., New York, NY (US)

(72) Inventors: Shailesh SINGH, Frisco, TX (US); Amalesh PRADHAN, Plano, TX (US); Katlen GARCIA, Frisco, TX (US); Aravind SUNDARAJ, Frisco, TX (US); Matt MCCLINTOCK, Lantana, TX (US); Nathan BIANCO, Longview, TX (US); Scott T RYAN, Plano, TX (US); Shawn RILEY, Plano, TX (US)

(73) Assignee: JPMorgan Chase Bank, N.A., New York, NY (US)

(21) Appl. No.: 18/789,160

(22) Filed: Jul. 30, 2024

(51) Int. Cl. G06F 21/62; G06F 16/21; G06F 16/23

(52) U.S. Cl. CPC G06F 21/6218; G06F 16/213; G06F 16/2358; G06F 2221/2141

(57) ABSTRACT

Various methods and processes, apparatuses or systems, and media for dynamically updating of metadata in a data catalog for a change in a data store via a looped configuration are disclosed. The present disclosure provides detecting the change in the data store, automatically pulling, via the data catalog, first metadata corresponding to the change in the data store; automatically generating second metadata corresponding to the change in the data store; updating third metadata stored in the data catalog to incorporate information included in the first metadata and the second metadata for providing updated metadata; and updating a data schema library to reflect the updated metadata, in which the updated metadata and the updated data schema library modify an access control to allow a user group to access the changed data object in the data store.

### TECHNICAL FIELD

This disclosure generally relates to dynamic updating of data catalog to reflect current status of a data store in real-time and dynamic data governance and access control. More specifically, the present disclosure relates to connecting a data catalog for directly sourcing data attributes for data objects or tables in real-time, and dynamically synchronizing the directly sourced data attributes for dynamically providing fresh access control.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Conventional data security platform may utilize attribute-based access control to manage access of information in a data store. However, as the data objects or tables stored in the data store is subject to various modifications and manipulations, and the data store may additionally receive large amounts of new data objects on a daily basis, the conventional data security platform's stored attribute access control may quickly stale and may not accurately reflect or correspond to the data objects or tables stored in the data store. In addition, when data objects or tables stored in the data store are utilized for generating new data objects or tables, the conventional data security platform may be unaware of the newly generated objects or tables and may not implement proper access controls for providing access to such objects or tables.

In consideration of the above noted technical deficiencies, some of the authorized users may be unable to properly access the underlying data objects or tables.

### SUMMARY

The present disclosure, through one or more of its various aspects, embodiments, and/or specific features or sub-components, provides, among other features, a method for dynamically updating of information in a data catalog for a change in a data store via a looped configuration by utilizing one or more processors along with allocated memory is provided. The method includes detecting, by the one or more processors, the change in the data store, wherein the change in the data store involves a change in a data object stored in the data store; automatically pulling, by the one or more processors and via the data catalog, first metadata corresponding to the change in the data store, wherein the first metadata includes one or more attributes corresponding to the data object stored in the data store for which the change was detected; automatically generating, by the one or more processors, second metadata corresponding to the change in the data store, wherein the second metadata control access to the data object stored in the data store for which the change was detected; updating, by the one or more processors, third metadata stored in the data catalog to incorporate information included in the first metadata and the second metadata for providing updated metadata; and updating, by the one or more processors, a data schema library to reflect the updated metadata, wherein the updated metadata and the updated data schema library modify access control to allow a user group to access the data object in the data store for which the change was detected, and wherein the data schema library manages changes to data schemas.

In some embodiments, the data catalog, the data store, and the data schema library are included in the looped configuration, such that a modification in one component in the looped configuration will automatically trigger updates to other components in the looped configuration.

In some embodiments, the change in the data store in the looped configuration automatically triggers a change in the data catalog in the looped configuration.

In some embodiments, the change in the data catalog in the looped configuration triggers a change in the data schema library in the looped configuration.

In some embodiments, the change in the data store includes adding of the data object that is new to the data store.

In some embodiments, the change in the data store includes modifying of the data object that was previously existing in the data store.

In some embodiments, the method may further include: pulling, by the one or more processors, the updated metadata from the data catalog; feeding, by the one or more processors, the updated metadata into a data security/governance platform; deleting, by the one or more processors, reference to a data source corresponding to the data object that was previously existing in the data store; and inserting, by the one or more processors, reference to a data source corresponding to the modified data object.

In some embodiments, the method may further include: determining, by the one or more processors, an existence of a tag in the updated metadata pulled from the data catalog; and determining, by the one or more processors, an existence of a data object corresponding to the tag in the data store.

In some embodiments, when the one or more processors determine that the tag does not exist in the updated metadata pulled from the data catalog, executing a create tag function for creating the tag.

In some embodiments, when the one or more processors determine that the data object corresponding to the tag exists in the datastore, executing, by the one or more processors, a data source delete function for deleting a data source corresponding to the data object corresponding to the tag.

In some embodiments, when the one or more processors determine that the data object corresponding to the tag does not exist or when the data source delete function is executed, executing a data source create function for adding a data source for the modified data object.

In some embodiments, the method may further include: executing, by the one or more processors, a map tags function for mapping the tag to the added data source.

In some embodiments, the method may further include: executing, by the one or more processors, a refresh tags by data source name function for updating the third metadata stored in the data catalog to include the tag corresponding to the modified data object for allowing access to the modified data object by approved user groups.

In some embodiments, the method may further include: enforcing, by the data security/governance platform, one or more data security policies reflecting the updated metadata.

In some embodiments, the second metadata is generated via a machine learning algorithm model.

In some embodiments, the first metadata or the second metadata includes a tag corresponding to the data object.

In some embodiments, the data object is a table.

In some embodiments, the second metadata is inputted to the data catalog in real-time, according to a predetermined frequency or in response to a predetermined event.

In some embodiments, a system for dynamically updating of information in a data catalog for a change in a data store via a looped configuration is disclosed. The system may include: a processor; and a memory operatively connected to the processor via a communication interface, the memory storing computer readable instructions, when executed, may cause the processor to: detecting the change in the data store, wherein the change in the data store involves a change in a data object stored in the data store; automatically pulling, via the data catalog, first metadata corresponding to the change in the data store, wherein the first metadata includes one or more attributes corresponding to the data object stored in the data store for which the change was detected; automatically generating second metadata corresponding to the change in the data store, wherein the second metadata control access to the data object stored in the data store for which the change was detected; updating third metadata stored in the data catalog to incorporate information included in the first metadata and the second metadata for providing updated metadata; and updating a data schema library to reflect the updated metadata, wherein the updated metadata and the updated data schema library modify access control to allow a user group to access the data object in the data store for which the change was detected, and wherein the data schema library manages changes to data schemas.

In some embodiments, a non-transitory computer readable medium configured to store instructions for dynamically updating of information in a data catalog for a change in a data store via a looped configuration is disclosed. The instructions, when executed, may cause a processor to perform the following: detecting the change in the data store, wherein the change in the data store involves a change in a data object stored in the data store; automatically pulling, via the data catalog, first metadata corresponding to the change in the data store, wherein the first metadata includes one or more attributes corresponding to the data object stored in the data store for which the change was detected; automatically generating second metadata corresponding to the change in the data store, wherein the second metadata control access to the data object stored in the data store for which the change was detected; updating third metadata stored in the data catalog to incorporate information included in the first metadata and the second metadata for providing updated metadata; and updating a data schema library to reflect the updated metadata, wherein the updated metadata and the updated data schema library modify access control to allow a user group to access the data object in the data store for which the change was detected, and wherein the data schema library manages changes to data schemas.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for dynamically updating of various metadata, protection groups and attributes for detected change in a data object stored in a data store and dynamically providing access to the detected changed data object in accordance with an embodiment.

FIG. 2 illustrates a diagram of a network environment with a system for dynamically updating of various metadata, protection groups and attributes for detected change in a data object stored in a data store to dynamically provide access to the detected changed data object in accordance with an embodiment.

FIG. 3 illustrates a system configuration diagram for implementing a system for dynamically updating of various metadata, protection groups and attributes for detected change in a data object stored in a data store to dynamically provide access to the detected changed data object in accordance with an embodiment.

FIGS. 4A-4B illustrate a method for dynamically updating of various metadata, protection groups and attributes for detected change in a data object stored in a data store and dynamically providing access to the detected changed data object in accordance with an embodiment.

FIGS. 5A-5B illustrate system diagrams of a system for dynamically updating of various metadata, protection groups and attributes for detected change in a data object stored in a data store to dynamically provide access to the detected changed data object in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

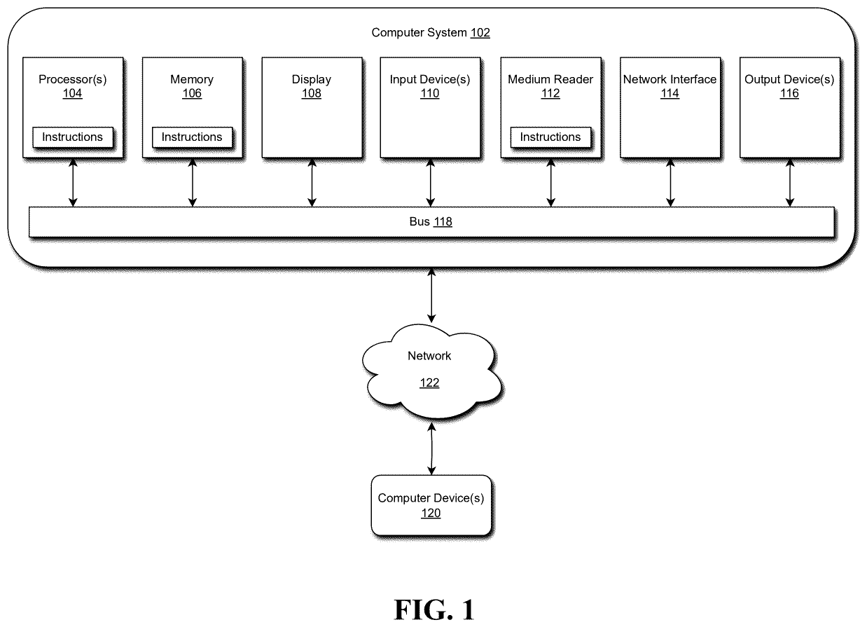

FIG. 1 is a system 100 for use in implementing a data catalog bridge module configured for dynamically updating of various metadata, protection groups and attributes for detected change in a data object stored in a data store and dynamically providing access to the detected changed data object in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the data catalog bridge module implemented by the system 100 may allow for dynamically updating of various metadata, protection groups and attributes for a detected change in a data object stored in a data store and dynamically providing access to the detected changed data object. Since the disclosed data catalog bridge module may be independently tuned or modified for optimal performance without affecting the configuration or data files. The configuration or data files, in some embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

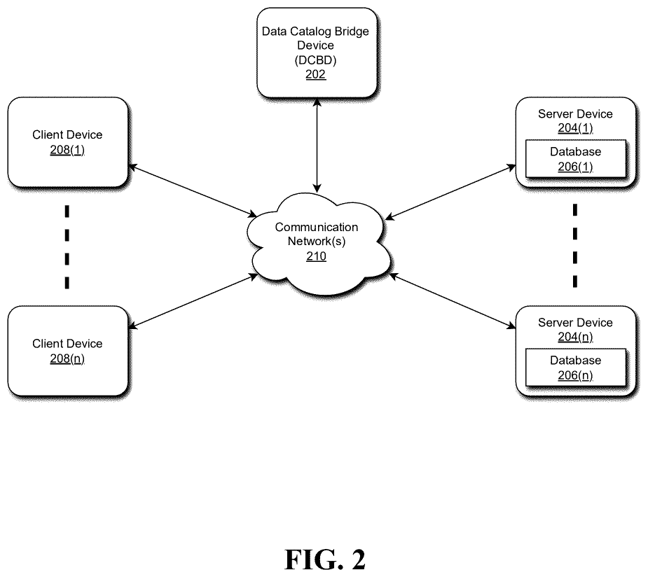

Referring to FIG. 2, a schematic of a network environment 200 for implementing a data catalog bridge device (DCBD) of the instant disclosure is illustrated.

In some embodiments, the above-described problems associated with conventional tools may be overcome by implementing a DCBD 202 as illustrated in FIG. 2 that may be configured for implementing a data catalog bridge module configured for dynamically updating of various metadata, protection groups and attributes for detected change in a data object stored in a data store and dynamically providing access to the detected changed data object, but the disclosure is not limited thereto.

The DCBD 202 may include one or more computer system 102s, as described with respect to FIG. 1, which in aggregate provide the necessary functions.

The DCBD 202 may store one or more applications that can include executable instructions that, when executed by the DCBD 202, cause the DCBD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DCBD 202 itself, may be located in virtual server(s) running in a cloud-based computing environment rather than being tied to one or more specific physical network computing devices. Also, the application(s) may be running in one or more virtual machines (VMs) executing on the DCBD 202. Additionally, in one or more embodiments of this technology, virtual machine(s) running on the DCBD 202 may be managed or supervised by a hypervisor.

In the network environment 200 of FIG. 2, the DCBD 202 may be coupled to a plurality of server devices 204(1)-204(n) that hosts a plurality of databases 206(1)-206(n), and also to a plurality of client devices 208(1)-208(n) via communication network(s) 210. A communication interface of the DCBD 202, such as the network interface 114 of the computer system 102 of FIG. 1, operatively couples and communicates between the DCBD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DCBD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DCBD 202 may be a standalone device or integrated with one or more other devices or apparatuses, such as one or more of the server devices 204(1)-204(n), for example. In one particular example, the DCBD 202 may be hosted by one of the server devices 204(1)-204(n), and other arrangements are also possible. Moreover, one or more of the devices of the DCBD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DCBD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the DCBD 202 that may efficiently provide a data catalog bridge module configured for dynamically updating of various metadata, protection groups and attributes for detected change in a data object stored in a data store and dynamically providing access to the detected changed data object, but the disclosure is not limited thereto.

The client devices 208(1)-208(n) may run interface applications, such as standard web browsers or standalone client applications, which may provide an interface to communicate with the DCBD 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the DCBD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the DCBD 202, the server devices 204(1)-204(n), or the client devices 208(1)-208(n), for example, may be configured to operate as virtual instances on the same physical machine. For example, one or more of the DCBD 202, the server devices 204(1)-204(n), or the client devices 208(1)-208(n) may operate on the same physical device rather than as separate devices communicating through communication network(s) 210. Additionally, there may be more or fewer DCBDs 202, server devices 204(1)-204(n), or client devices 208(1)-208(n) than illustrated in FIG. 2. In some embodiments, the DCBD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

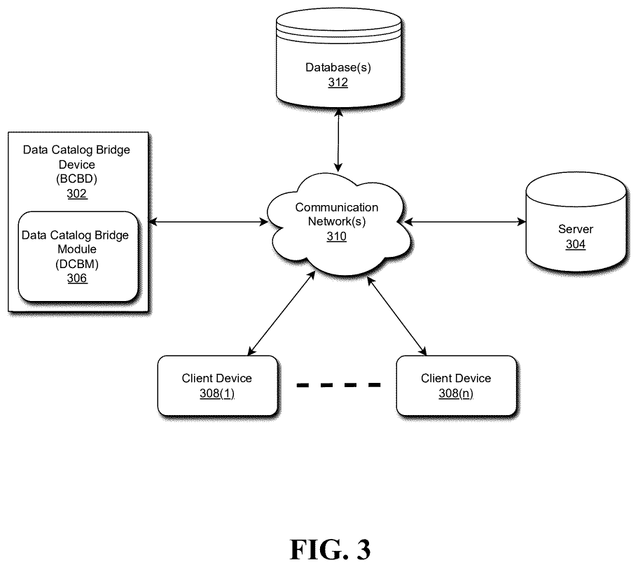

FIG. 3 illustrates a system diagram for implementing a DCBD having a data catalog bridge module (DCBM) in accordance with an embodiment.

As illustrated in FIG. 3, the system 300 may include an DCBD 302 within which an DCBM 306 is embedded, a server 304, a database(s) 312, a plurality of client devices 308(1) . . . 308(n), and a communication network 310.

In some embodiments, the DCBD 302 including the DCBM 306 may be connected to the server 304, and the database(s) 312 via the communication network 310. The DCBD 302 may also be connected to the plurality of client devices 308(1) . . . 308(n) via the communication network 310, but the disclosure is not limited thereto. The database(s) 312 may include one or more rule databases.

In an embodiment, the DCBD 302 is described and shown in FIG. 3 as including the DCBM 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the DCBM 306 may be configured to receive real-time feed of data from the plurality of client devices 308(1) . . . 308(n) and secondary sources via the communication network 310.

The DCBM 306 may be configured to: implement an active data catalog; detect, by the active data catalog, a change occurring in a data store, in which the change in the data store involves a change in a data object stored in the data store; automatically pulling, via the active data catalog, first metadata corresponding to the change in the data store, in which the first metadata includes one or more attributes corresponding to the data object stored in the data store for which the change was detected; automatically generating second metadata corresponding to the change in the data store, in which the second metadata control access to the data object stored in the data store for which the change was detected; updating, by the active data catalog, third metadata stored in the data catalog to incorporate information included in the first metadata and the second metadata for providing updated metadata; and causing an update, by the active data catalog, to a data schema library to reflect the updated metadata in the active data catalog, in which the updated metadata and the updated data schema library modify access control to allow a user group to access the data object in the data store for which the change was detected, but the disclosure is not limited thereto.

The plurality of client devices 308(1) . . . 308(n) are illustrated as being in communication with the DCBD 302. In this regard, the plurality of client devices 308(1) . . . 308(n) may be “clients” (e.g., customers) of the DCBD 302 and are described herein as such. Nevertheless, it is to be known and understood that the plurality of client devices 308(1) . . . 308(n) need not necessarily be “clients” of the DCBD 302, or any entity described in association therewith herein. Any additional or alternative relationship may exist between either or both of the plurality of client devices 308(1) . . . 308(n) and the DCBD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the DCBD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The DCBD 302 may be the same or similar to the DCBD 202 as described with respect to FIG. 2, including any features or combination of features described with respect thereto.

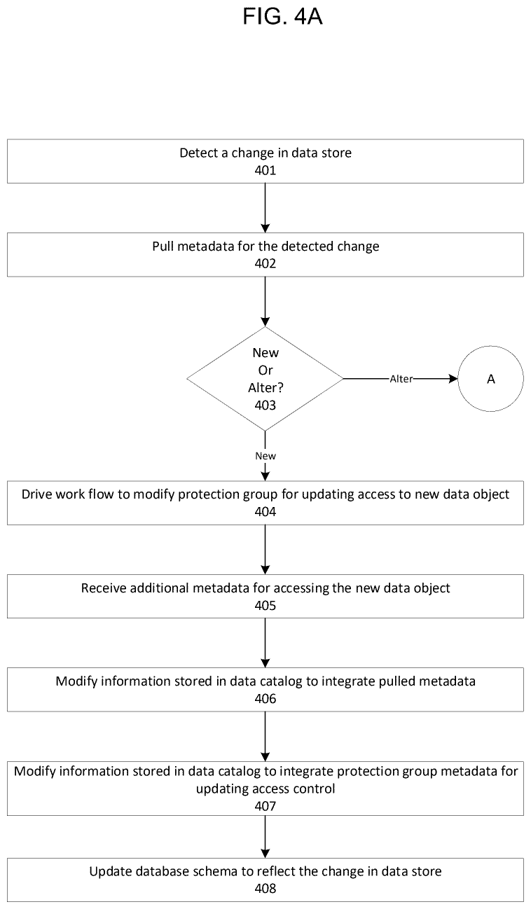

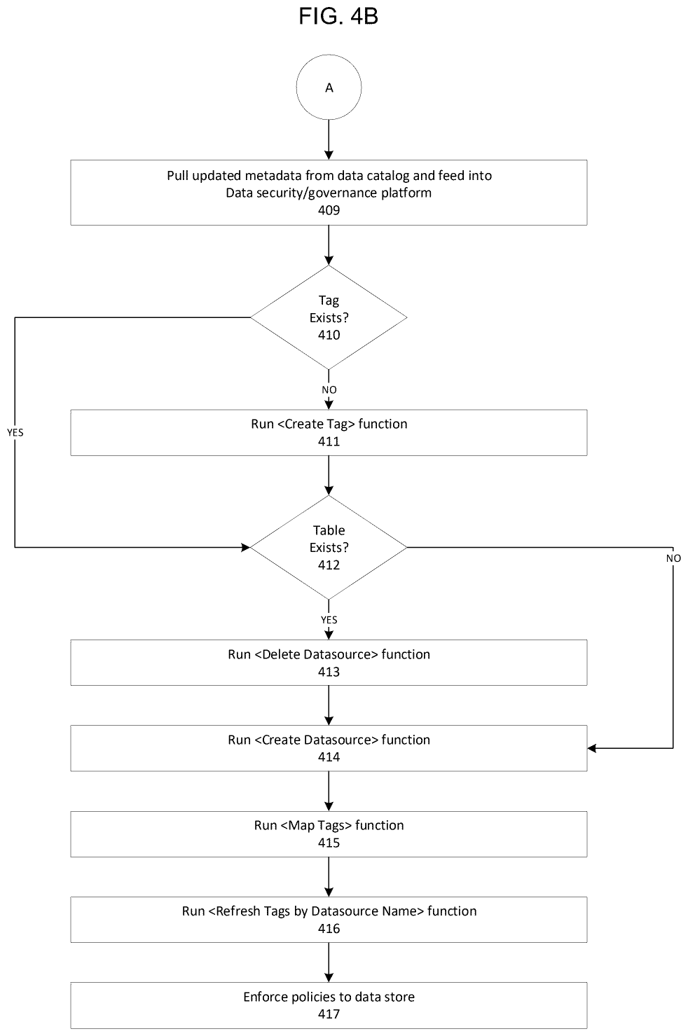

FIGS. 4A-4B illustrate a method for dynamically updating of various metadata, protection groups and attributes for detected change in a data object stored in a data store and dynamically providing access to the detected changed data object in accordance with an embodiment.

According to exemplary aspects, a data catalog may be connected to a data store to directly source one or more data attributes for a data object. According to further aspects, the data catalog may allow the one or more data attributes to be sourced in real-time or contemporaneously to dynamically indicate any modification performed on a data object or table stored in a data store in real-time. Once a modification on the data store is detected, data attributes or metadata corresponding to a changed data object may be pulled by the data catalog in real-time for synchronization with existing information, and additional metadata directed to protection or access grouping may also be generated in real-time based on the changed data object for synchronization with the existing information in the data catalog to provide up-to-date control access to current information stored in the data store. Accordingly, the most up-to-date information in the data store may be reflected with minimal to no noticeable lag time. However, aspects of the present disclosure are not limited thereto, such that the data attributes of various data objects stored at a data store may be also or alternatively be updated according to a predetermined frequency, based on predetermined events, in response to an unusual activity, as directed by a machine learning model, or the like.

In operation 401, a change is detected in a data store. According to exemplary aspects, the change may be creation of a new table or a new column, row, value in a table. However, aspects of the present disclosure are not limited thereto, such that the change may refer to creation of any data object in the data store. Moreover, the change may additionally include a modification of an existing data object or table. In an example, a data scientist working with data objects or tables stored in the data store may manipulate or utilize existing data objects or tables to generate new data objects. In another example, new data objects or tables may be created from scratch or imported. Yet, in another example, one or more values within an existing table may be modified.

According to exemplary aspects, the data store may refer to a digital repository that persistently stores and manages collection of data. In an example, the collection of data may be structured data. Further, the data store may include repositories like databases, but aspects of the present disclosure are not limited thereto, such that it may additionally or alternatively include simpler store types.

In operation 402, metadata or attributes corresponding to the change detected in the data store is pulled by a data catalog. Although aspects of the present disclosure describes pulling operation by the data catalog, aspects of the present disclosure are not limited thereto, such that the data store may be configured to send a notification of the change detected or incurred in the data store. According to further aspects, the data catalog and the data store may be linked in a loop, such that any change in a data object in the data store may be reflected by the metadata stored in the data catalog in real-time or contemporaneously.

According to exemplary aspects, the metadata pulled or received by the data catalog may provide a summary of basic information about the corresponding data object, which makes identification and utilization of such data objects more efficient. In an example, metadata may be structural metadata, administrative metadata, reference metadata, statistical metadata, legal metadata and/or the like.

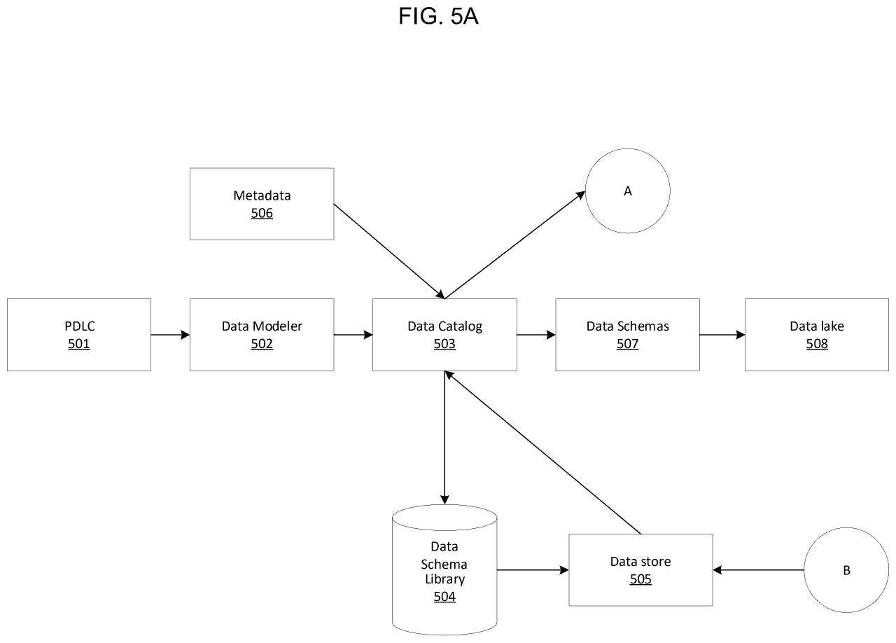

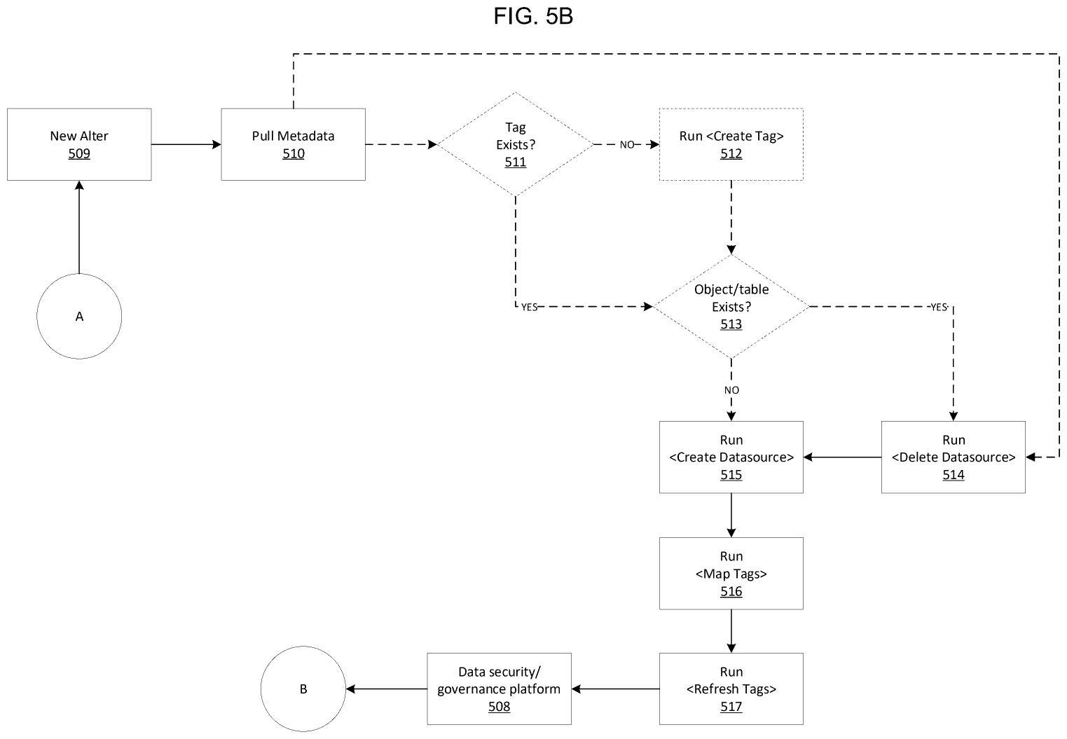

In operation 403, a determination of whether the detected change in the data store is directed to a creation of a new data object or modification to an existing data object is made. According to exemplary aspects, the modification of the existing data object may be referred to as an alter. If the detected change is determined to be a modification to an existing data object, then the method proceeds to operation 409 in FIG. 5B. Alternatively, if the detected change is determined to be creation of a new data object, the method proceeds to operation 404.

In operation 404, a work flow may be initiated to modify or set metadata directed to protection or permission grouping for updating access to the new data object detected in the data store. According to exemplary aspects, protection or permission grouping or group may correspond to a data group of the changed data object. In an example, the work flow may be an automated process that is triggered upon detection of the new data object or change in the data store. Additionally, the work flow may include one or more approval processes. However, aspects of the present disclosure are not limited thereto, such that the work flow may not include any approvals, or the approvals may be selectively applied based on the data object that is detected.

In operation 405, the work flow may provide additional metadata directed to protection or permission group for providing access, for a corresponding user group, to the new data object to the data catalog. In an example, the additional metadata may refer to protection or permission group(s) that correspond to the new data object(s). According to exemplary aspects, the protection or permission group metadata may be provided to the data catalog contemporaneously or in real-time with the detected change in the data store. However, aspects of the present disclosure are not limited thereto, such that the protection or permission group metadata may be provided in accordance with a predetermined frequency or in response to predetermined event(s).

In operation 406, information stored in the data catalog is modified to integrate the metadata pulled in operation 402. Further, in operation 407, information stored in the data catalog is further modified to integrate the protection or permission group metadata received in operation 405 for updating access control to allow a user group to access the changed data object.

In operation 408, database schema is updated with the modified information in the data catalog reflecting changes in the data store. According to exemplary aspects, a data schema library for managing and applying database schema changes may be connected with the data catalog and data store in a loop. Accordingly, any change made or detected in the data store may trigger corresponding information to be updated in the data catalog with various metadata, which will in turn update corresponding data schema to reflect the change made in the data store to provide the up-to-date information of data objects stored in the data store while providing up-to-date access to such data objects, at any given time.

In operation 409 in FIG. 4B, metadata may be pulled from the data catalog and fed into a data security/governance platform. According to exemplary aspects, the data security/governance platform may tag one or more data objects, provide data security and access control based on such tags. Although metadata is described as being pulled by the data security/governance platform, aspects of the disclosure are not limited thereto, such that the data catalog may be configured to transmit the metadata to the data security/governance platform upon determining that the change detected in the data store is a modification of an existing data object.

In operation 410, based on the metadata pulled from the data catalog, a check for existence of a tag in the pulled metadata is performed. According to exemplary aspects, a tag may refer to metadata or attribute. If it is determined that tag does not exist in the pulled metadata in operation 410, create tag function is executed in operation 411 for generating a new tag for the modified data object. On the other hand, if it is determined that the tag exists within the pulled metadata in operation 410, the method proceeds to operation 412.

In operation 412, a check for an existing table or data object prior to the detected modification is made. According to exemplary aspects, a table may refer to a data object. However, aspects of the present disclosure are not limited thereto, such that the data object may include other forms of data. If it is determined that previous table or data object is present, then delete data source function is executed to delete a data source corresponding to the previously existing table or data object in operation 413. On the other hand, if it is determined that no previously existing table or data object is present, then the method proceeds to operation 414.

In operation 414, once the data source corresponding to the previously existing data object or table is deleted or confirmed as not existing, a data source corresponding to the data object that has been modified will be established to replace reference to the previously existing data object. In operation 415, metadata or tag(s) may be mapped to the modified data object in the data catalog, such that the existing tag or newly created tag may be mapped to the modified data object.

In operation 416, refresh tags by data source function is executed to refresh the tags with respect to the modified data object in the data security/governance platform for allowing a user group to properly access the modified data object. According to exemplary aspects, the updated data security/governance platform may automatically provide the updated information to the data store, which may in turn automatically update the data catalog.

In operation 417, the data security/governance platform enforces policies to the data store, such that updated metadata stored in the data catalog reflect the modified data object stored in the data store to permit a user group to access the modified data object.

FIGS. 5A-5B illustrates system diagrams of a system for dynamically updating of various metadata, protection groups and attributes for detected change in a data object stored in a data store to dynamically provide access to the detected changed data object in accordance with an embodiment.

According to exemplary aspects, a system for dynamically updating of various metadata and attributes for detected change in a database includes a product development life cycle (PDLC) 501, a data modeler 502, a data catalog 503, a data schema library 504, a data store 505, metadata 506, data schemas 507, and events ingested into data lake 508. According to further aspects, the data catalog 503, the data schema library 504, the data store 505 and the metadata 506 may provide a looped configuration for chaining of related operations.

The PDLC 501 may refer to the process of defining, designing, developing, manufacturing, launching and/or maintaining a software product from initial concepts or designs. In an example, the software product may include an application, an algorithm, a computer model, ML or AI model, a function, and the like.

The data modeler 502 may refer to a system or device that designs computer databases and data models used to turn complex organizational data into usable computer systems. According to exemplary aspects, the data modeler 502 may use one or more of relational, dimensional, and NoSQL databases to model a data flow or structure for managing the flow of information between systems in an organization. However, aspects of the present disclosure are not limited thereto, such that other types of databases may be utilized for the management of flow of information. According to exemplary aspects, the data modeler 502 may configure the flow of information via the databases based on one or more software product generated via the PDLC 501.

According to exemplary aspects, the data catalog 503 may be connected to the data store 505 in a loop so that metadata stored in the data catalog 503 may be directly sourced for the data objects stored and managed by the data store 505. Metadata may summarize basic information about the data object, which allows making finding and working with particular instances of the data object easier. Metadata may not indicate what the data object is, but may provide various descriptive information or attributes that describes or characterizes the respective data object. In an example, metadata may help to explain provenance of a data object, such as origin, nature and lineage.

The data catalog 503 may refer to an organized inventory of data assets, which enables users to locate, access and/or evaluate data in a centralized location. In an example, the data catalog 503 may be cataloged by application, function, data source, data modified or other grouping. The data catalog 503 may leverage metadata to allow a data consumer to quickly search a data landscape of an organization, and better understand data that are available for driving analysis. Accordingly, it is vital that the data catalog 503 has the most updated information at any given time, which is made available based on the loop configuration but was unavailable in the conventional practice.

More specifically, the data catalog 503 may be a database instance of metadata, in which definitions or attributes of database objects, such as indexes, tags, user groups, permissions groups, protection groups and the like may be stored. According to exemplary aspects, data catalog may store various attributes with reference to one of more data objects identified by the data modeler 502.

Moreover, the data catalog 503 may be configured to provide data access control. In an example, the data catalog 503 may utilize metadata directed to access or permission group, which may be updated in real-time or near real-time based on the looped configuration, for determining proper access to corresponding data objects in the data store 505. According to exemplary aspects, as data objects are created or modified in the data store 505, the data catalog 503 may be updated with metadata corresponding to the newly created or modified data objects in real time. Moreover, additional metadata, tag, protection groups or access groups, may also be provided to the data catalog 503 to update access information so that appropriate users may be able to access new or modified objects stored in the data store 505. In an example, the additional metadata, tag, protection groups or access groups may additionally be provided via an intermittent update according to a predetermined frequency or in response to a predetermined event. In further aspects, the additional metadata, tag, protection groups or access groups may be automatically provided to the data catalog 503 in response to a detected change in the data store 505. In an example, the additional metadata, tag, protection groups or access groups, as well as metadata corresponding to the newly created or modified data objects, may be automatically generated in accordance with predetermined rules or in accordance to a machine learning (ML) or artificial intelligence (ML) model.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

According to further aspects, the data catalog 503 may be connected, directly and/or indirectly, to the data store 505, the data schema library 504 and the data schemas 507. Based on the connectivity between the data catalog 503 and the data store 505, any change made in the data store 505 may be cause or drive a contemporaneous change to corresponding metadata or attribute information stored in the data catalog 503. Accordingly, the data catalog 503 may reflect the most up-to-date information in the data store 505 at any given time.

Moreover, the data catalog 503 is also connected to the data schemas 507, such that a data schema reflective of the updated data object stored in the data store 505 may be generated even when the data scheme 507 may not have a direct connection to the data store 505. Accordingly, regardless of the frequency or timing of changes made to data objects stored in the data store 505, accurate data schema information may be provided at any given moment.

The data schema library 504 may refer to a database schema change management platform, which allows for tracking, managing and applying database schema changes for generating data schemas 507. According to exemplary aspects, the data schema library 504 may receive or detect a change request for a data object in the data store 505, track and store such changes, and apply the stored changes in generating a resulting data schema. The data schema library 504 may be connected with the data catalog 503 and the data store 505 in a loop. Accordingly, changes in the data store 505 and/or data catalog 503 may be automatically reflected in the data schemas 507. Further, access to such change request may be provide in accordance with user access controls for respective data objects, which may be stored and/or managed by the data catalog 503 and correspondingly reflected in the data schema library 504. In an example, the change request may include a request to create a new data object or alter. An alter may refer to a modification to a data object, which may include, without limitation, adding or removing of columns or indexes to or from a table.

The data store 505 may refer to a digital repository that persistently stores and manages collection of data. In an example, the collection of data may be structured data. According to exemplary aspects, the data store 505 may include repositories like databases, but aspects of the present disclosure are not limited thereto, such that it may additionally or alternatively include simpler store types.

As illustrated in FIG. 5A, the data store 505 is connected to the data catalog 503, the data schema library 504 and the metadata 506. The four connected components create an internal loop where a signal drives operations of the connected components, such that a change in one component will cause corresponding changes to occur in the other connected components, as well as components not included in the loop. In addition, updated information corresponding to any changes occurring within the data store 505 may be reflected in the data catalog 503 and the data schema library 504, and resultingly, in the data schemas 507. As a result, when a modification occurs (e.g., generation of new data objects using existing data objects within the data store 505, modification of existing data object, or etc.) within the data store 505, other components may be aware of the modifications that occurred within the data store 505 and correspondingly updated.

More specifically, when a modification occurs in the data store 505, the data catalog 503 may pull corresponding metadata for the modification. For example, the pulled metadata may indicate a person responsible for the detected modification, date of modification, source of the modification and other relevant information. In addition, when the modification occurs in the data store 505, an automated workflow may be initiated for generating corresponding tags, protection groups, access groups or similar metadata for updating access information for the data object(s) modified in the data store 505. The generated tags, protection groups, access groups or similar metadata may then be provided to the data catalog 503.

In addition to the above, once the data catalog 503 has been updated with the metadata, the data catalog 503 integrates the metadata received with the modified data objects and feeds the information back to the data schema library 504 and the data store 505. In addition, the data catalog 503 with the data schema library 504 may provide the updated information and apply corresponding database schema changes in generating the data schemas 507. Accordingly, based on the loop configuration provided in FIG. 5A, the modification to the data objects in the data store 505 may be automatically updated with corresponding metadata and access/protection group setting, so that appropriate users may have access to the most up-to-date information corresponding to the data objects stored in the data store 505 for review, utilization, and/or modifications.

According to exemplary aspects, metadata 506 may include, without limitation, access control metadata corresponding to the data objects and/or groupings of the data objects stored in the data store 505. In an example, the metadata 506 may be automatically generated based on the detected change to a data object in the data store 505 and provided to the data catalog 503 in real-time or near real-time. However, aspects of the present disclosure are not limited thereto, such that the metadata 506 may be inputted to the data catalog 503 at a predetermined frequency or in response to predetermined events.

According to exemplary aspects, the data schemas 507 may be updated based on the information provided in the data catalog 503 and the data schema library 504. At least since the above noted configuration allows for the data catalog 503 to be provided with the most up-to-date metadata corresponding to the modifications occurring in the data store 505, the data schema library 504 may accurately reflect the updated information provided in the data store 505 for generating of the resulting data schemas 507. In an example, data schema may refer an object container file format. More specifically, each file may have a schema or arrangement, and all data objects stored in the file may be written according to the specified schema. Here, at least since the data schemas 507 are driven by the information provided in the data catalog 503 and the data schema library 504, the data schemas 507 may specify the updated access/protection groups and reflect the modified data object information in the data store 505, including new or modified data objects.

When the data object information included in the data catalog 503 have been arranged according to a specific data schema provided in the data schema 507, the arranged data object information may be ingested as one or more events into the data lake 508. In an example, a data lake may refer to a centralized repository designed to store, process and secure large amounts of structured, semi-structured and unstructured. Moreover, a data lake may be capable of storing data in its native format and process variations of it, while ignoring size limits.

In addition to the above, when a new alter 509 is generated, operations or functions including metadata pull function 510, check for tag existence function 511, run create tag function 512, check for object/table existence function 513, run delete data source function 14, run create data source function 515, run map tag function 516 and run refresh tags function 517 may be performed. However, aspects of the present disclosure are not limited there to, such that additional or less operations/functions may be performed or optionally performed. Moreover, operations or functions including the check for tag existence function 511, the run create tag function 512 and the check for object/table existence function 513 may be optionally performed and not necessary, such that running of delete data source function 514 is always performed.

In an example, an alter may refer to a modification to an existing data object or table, rather than adding of new data objects. In this regard, existing data object or table may already have existing metadata, which would require an update thereto to reflect any medication made to the existing data object. However, at times, reconciling or updating of metadata may cause system performance issues, such as slower processing.

Accordingly, when existing metadata and/or data object for a modified data object causes performance issues, a set of processes may be performed to remove certain metadata for improving system performance when dealing with alters. The set of processes may include one or more operations illustrated in FIG. 5B. For example, checking of existing tag in operation 511 may be performed to selectively check for an existing tag within the pulled metadata. In addition, a new tag may be created, if necessary or when the tag is determined to be missing in the pulled metadata, in operation 512. Further, a check for previously existing data object or table (e.g., data object prior to modification) may be performed in operation 513 for deletion of a data source corresponding to previously existing data objects or table in operation 514. Once the data source corresponding to the previously existing data object or table is deleted or confirmed as not existing, a data source corresponding to the data object that has been modified will take place of the data source corresponding to the previously existing data object in operation 515, and metadata or tags may be mapped to the modified data object in the data catalog in operation 516.

Once the refresh tags 517 operation is executed, the metadata mapping output may be provided and updated in the data security/governance platform 508 for modification of corresponding data schemas. Moreover, the updated data security/governance platform 508 may automatically provide the updated information to the data store 505, which may in turn automatically update the data catalog 503. Accordingly, based on the presently disclosed system flow, data catalog 503 is always up-to-date with the most recent information, which is then utilized to build/update data schemas 507.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for dynamically updating of information in a data catalog for a change in a data store via a looped configuration by utilizing one or more processors along with allocated memory, the method comprising:
detecting, by the one or more processors, the change in the data store, wherein the change in the data store involves a change in a data object stored in the data store;
automatically pulling, by the one or more processors and via the data catalog, first metadata corresponding to the change in the data store, wherein the first metadata includes one or more attributes corresponding to the data object stored in the data store for which the change was detected;
automatically generating, by the one or more processors, second metadata corresponding to the change in the data store, wherein the second metadata control access to the data object stored in the data store for which the change was detected;
updating, by the one or more processors, third metadata stored in the data catalog to incorporate information included in the first metadata and the second metadata for providing updated metadata; and
updating, by the one or more processors, a data schema library to reflect the updated metadata, wherein the updated metadata and the updated data schema library modify access control to allow a user group to access the data object in the data store for which the change was detected, and wherein the data schema library manages changes to data schemas.

2. The method according to claim 1, wherein the data catalog, the data store, and the data schema library are included in the looped configuration, such that a modification in one component in the looped configuration will automatically trigger updates to other components in the looped configuration.

3. The method according to claim 2, wherein the change in the data store in the looped configuration automatically triggers a change in the data catalog in the looped configuration.

4. The method according to claim 3, wherein the change in the data catalog in the looped configuration triggers a change in the data schema library in the looped configuration.

5. The method according to claim 1, wherein the change in the data store includes adding of the data object that is new to the data store.

6. The method according to claim 1, wherein the change in the data store includes modifying of the data object that was previously existing in the data store.

7. The method according to claim 6, further comprising:
pulling, by the one or more processors, the updated metadata from the data catalog;
feeding, by the one or more processors, the updated metadata into a data security/governance platform;
deleting, by the one or more processors, reference to a data source corresponding to the data object that was previously existing in the data store; and
inserting, by the one or more processors, reference to a data source corresponding to the modified data object.

8. The method according to claim 7, further comprising:
determining, by the one or more processors, an existence of a tag in the updated metadata pulled from the data catalog; and
determining, by the one or more processors, an existence of a data object corresponding to the tag in the data store.

9. The method according to claim 8, wherein, when the one or more processors determine that the tag does not exist in the updated metadata pulled from the data catalog, executing a create tag function for creating the tag.

10. The method according to claim 8, wherein, when the one or more processors determine that the data object corresponding to the tag exists in the datastore, executing, by the one or more processors, a data source delete function for deleting a data source corresponding to the data object corresponding to the tag.

11. The method according to claim 10, wherein, when the one or more processors determine that the data object corresponding to the tag does not exist or when the data source delete function is executed, executing a data source create function for adding a data source for the modified data object.

12. The method according to claim 11, further comprising:
executing, by the one or more processors, a map tags function for mapping the tag to the added data source.

13. The method according to claim 12, further comprising:
executing, by the one or more processors, a refresh tags by data source name function for updating the third metadata stored in the data catalog to include the tag corresponding to the modified data object for allowing access to the modified data object by approved user groups.

14. The method according to claim 13, further comprising:
enforcing, by the data security/governance platform, one or more data security policies reflecting the updated metadata.

15. The method according to claim 1, wherein the second metadata is generated via a machine learning algorithm model.

16. The method according to claim 1, wherein the first metadata or the second metadata includes a tag corresponding to the data object.

17. The method according to claim 1, wherein the data object is a table.

18. The method according to claim 1, wherein the second metadata is inputted to the data catalog in real-time, according to a predetermined frequency or in response to a predetermined event.

19. A system for dynamically updating of information in a data catalog for a change in a data store via a looped configuration, the system comprising:
a processor; and
a memory operatively connected to the processor via a communication interface, the memory storing computer readable instructions, when executed, causes the processor to:
detecting the change in the data store, wherein the change in the data store involves a change in a data object stored in the data store;
automatically pulling, via the data catalog, first metadata corresponding to the change in the data store, wherein the first metadata includes one or more attributes corresponding to the data object stored in the data store for which the change was detected;
automatically generating second metadata corresponding to the change in the data store, wherein the second metadata control access to the data object stored in the data store for which the change was detected;
updating third metadata stored in the data catalog to incorporate information included in the first metadata and the second metadata for providing updated metadata; and
updating a data schema library to reflect the updated metadata, wherein the updated metadata and the updated data schema library modify access control to allow a user group to access the data object in the data store for which the change was detected, and wherein the data schema library manages changes to data schemas.

20. A non-transitory computer readable medium configured to store instructions for dynamically updating of information in a data catalog for a change in a data store via a looped configuration, the instructions, when executed, cause a processor to perform the following:
detecting the change in the data store, wherein the change in the data store involves a change in a data object stored in the data store;
automatically pulling, via the data catalog, first metadata corresponding to the change in the data store, wherein the first metadata includes one or more attributes corresponding to the data object stored in the data store for which the change was detected;
automatically generating second metadata corresponding to the change in the data store, wherein the second metadata control access to the data object stored in the data store for which the change was detected;
updating third metadata stored in the data catalog to incorporate information included in the first metadata and the second metadata for providing updated metadata; and
updating a data schema library to reflect the updated metadata, wherein the updated metadata and the updated data schema library modify access control to allow a user group to access the data object in the data store for which the change was detected, and wherein the data schema library manages changes to data schemas.
